(19) United States
(12) Patent Application Publication
(10) Pub. No.: US 2010/0299760 A1
(43) Pub. Date: Nov. 25, 2010

(54) COMMUNICATION SYSTEM FOR TRADE FAIRS

(76) Inventors: Richard James Hampson, Harpenden (GB); Richard Ian Rickwood, Harpenden (GB); Jose Carlos Leonardo Nogueira, Harpenden (GB)

Correspondence Address: HAYES SOLOWAY P.C., 3450 E. SUNRISE DRIVE, SUITE 140, TUCSON, AZ, 85718, US

(21) Appl. No.: 12/786,172

(22) Filed: May 24, 2010

(30) Foreign Application Priority Data
May 22, 2009 (GB) GB 0908886.5

(51) Int. Cl. G06F 21/24; G06F 13/12; G06F 3/048

(52) U.S. Cl. 726/28; 710/63; 715/810

(57) ABSTRACT

The present invention provides a communication system for communication between exhibitors and visitors at trade fairs, exhibitions, conferences and the like, which comprises:

i) a dedicated contact data organiser unit, being a stand-alone handheld device comprising a processor housed in its own casing, the casing housing internal data storage and having at least one USB port; and
ii) a pair of USB flash drives, one configured for use by an exhibitor and the other configured for use by a visitor,
wherein, in use, the contact data organiser unit holds a first set of data of the exhibitor's products and services and will transfer that data to a visitor USB flash drive that is coupled to the USB port and will build and hold a second set of data of the visitors who have coupled their visitor USB flash drive to the contact data organiser unit.

### FIELD OF THE INVENTION

The present invention concerns improvements in and relating to a communication system for trade fairs, exhibitions, conferences and the like and provides a method, apparatus and system that removes the need for exchange of printed media at such events/venues.

### BACKGROUND TO THE INVENTION

Trade fairs, exhibitions, conferences and the like are a key element of national and international commerce and academia, representing a focal point in time and place where parties with common interests can meet, promote and exchange information to optimal effect. These events invariably entail brochures or leaflets being handed out by exhibitors (the term ‘exhibitor’ may include conference presenters/sponsors) and business cards or other paperwork with contact details being exchanged between exhibitors and visitors (the term ‘visitor’ may include conference attendees or delegates). Use of printed media at these exhibitions and conferences can be very high and the associated costs and environmental concerns increase the need for less paper intensive alternatives. Less reliance on paper will reduce, amongst others, costs of transporting such media, printing costs, paper purchasing costs and recycling costs.

Others have sought to achieve lower reliance on paper in trade fairs, exhibitions, conferences in the past through use of electronic data transfer means but had only limited success. For example, EP 1,261,942 B describes a method and system for electronically selecting and collecting brochures from trade fairs that comprises use of a bar-coded ticket or encoded card by the visitor that is presented to a card reader at an exhibitor's stand, the reader then reads the card's ID and information request and transmits this to a central server to collate the information for the visitor so that he may be copied the information from that exhibitor and any others he selects by disk or email at the end of the exhibition. Another system is described in GB 2,427,061 B that comprises a point of display document dispenser comprising a desk-top advertising display and which may be used at a stand of a trade fair or exhibition. This has a USB socket for a USB flash drive for transfer of information from the dispenser to the visitor's USB flash drive on the user pressing a transfer activation button.

The present invention seeks to provide a more viable system for information exchange that is bi-directional to provide information to an exhibition visitor from an exhibitor and from the visitor to the exhibitor while being very compact, secure, reliable and requiring minimal associated hardware/infrastructure at the exhibition.

### SUMMARY OF THE INVENTION

According to a first aspect of the present invention there is provided a communication system for communication between exhibitors and visitors at trade fairs, exhibitions, conferences and the like, which comprises:

i) a dedicated contact data organiser unit, being a stand-alone handheld device comprising a processor housed in its own casing, the casing housing internal data storage and having at least one USB port; and
ii) a pair of USB flash drives, one configured for use by an exhibitor and the other configured for use by a visitor,
wherein, in use, the contact data organiser unit holds a first set of data of the exhibitor's products and services and will transfer that data to a visitor USB flash drive that is coupled to the USB port and will build and hold a second set of data of the visitors who have coupled their visitor USB flash drive to the contact data organiser unit.

Suitably the internal data storage of the contact data organiser unit comprises a flash memory which may, for example, be CF (Compact Flash) or SD (Secure Digital) memory.

Preferably each exhibitor USB flash is issued with an authorisation code or encryption key for the exhibitor using that USB flash and associated contact data organiser unit. The processor of the contact data organiser unit is suitably configured to check, whenever a USB flash drive is coupled to the USB port, whether the coupled USB flash drive has the required key or code to enable download of the second set of data to the exhibitor USB flash drive.

The system thus comprises a small stand-alone handheld device to distribute exhibition marketing literature or other content to inexpensive USB flash drives (UFD's) and collect users' contact details or other information from those same UFD's, all without the use of a personal computer. The system is very efficient and secure and avoids need to network to a PC at the exhibition allowing the exhibition transfer of information to occur real-time for the visitor and with contacts feedback to the exhibitor being collated locally in the compact handheld organiser device and downloadable to the exhibitors USB flash drive securely on-demand.

### BRIEF DESCRIPTION OF THE DRAWINGS

A preferred embodiment of the present invention will now be further described, by way of example only, with reference to the accompanying drawings, in which:

FIG. 1 is a front view of the three components of the system for use at an exhibition/trade fair or conference;

FIGS. 2, 3 and 4 are respectively, a top end elevation view, a bottom end elevation view and a side elevation view of the contact data organiser unit (GECO unit) of the system;

FIGS. 5, 6, 7 and 8 are information flow diagrams of the first, second, third and fourth stages, respectively, of the implementation of the system; and

FIG. 9 is a logic flowchart of the contact data organiser unit (GECO unit).

### DESCRIPTION OF THE PREFERRED EMBODIMENT

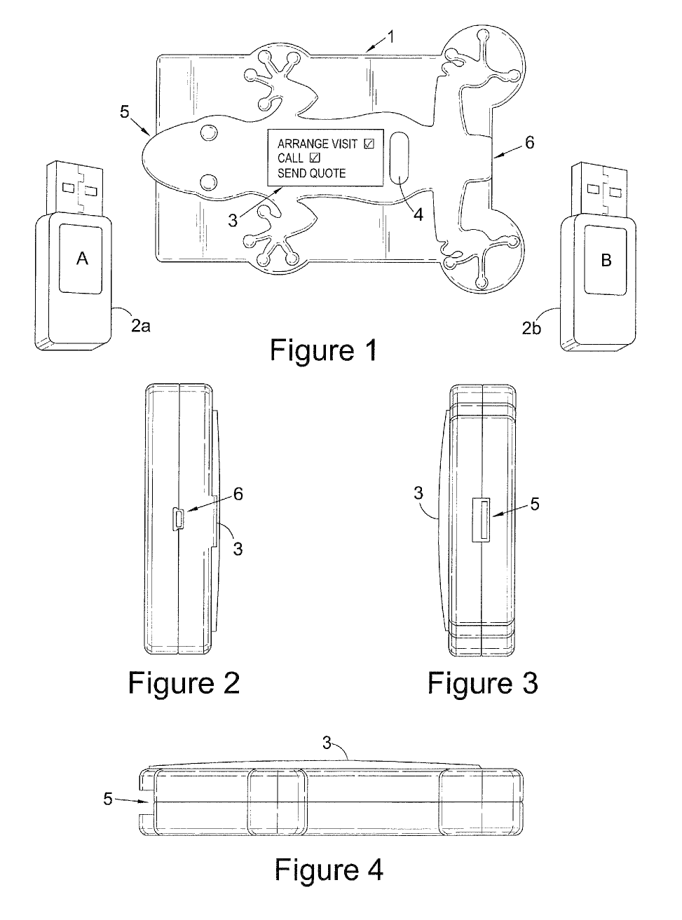

Referring to FIGS. 1 to 4, the preferred embodiment of the system comprises firstly a dedicated contact data organiser unit 1, that is alternatively referred to as ‘GECO device’ in the attached Figures. The organiser unit 1 is a compact, generally tablet-shaped, small/pocket-sized (eg 80 mm×120 mm×20 mm) stand-alone handheld device comprising a processor unit housed in its own casing 2.

The casing 2 has on its upper face an OLED display screen 3 or other compact high quality display screen and a scrolling wheel 4 or other simple selector/cursor control. The casing 2 further has a USB-A socket 5 at one end and a mini-B USB socket 6 at the other end. The latter allows for fast data upload to the organiser unit 1 from a PC during initialisation (pre-loading with exhibitor information) of the organiser unit 1 and also allows charging of the organiser unit 1.

The casing 2 houses a processor/microcontroller with ROM containing firmware to run the system/data transfer process. The casing 2 also houses internal memory, suitably flash memory, to hold the data sets to be transferred in use. The microcontroller and internal flash memory are suitably mounted on a common PCB and linked to the first USB socket 5, second USB/charging socket 6, cursor control 4 and display screen 3. The system also comprises two types of mass storage/flash memory devices, exemplified as USB 2.0 stick USB Flash Drives although USB 1.0 Flash Drives or other format devices may be used. The first USB stick 2a is configured for use by the exhibitor and the second USB stick 2b is configured for use by the visitor.

The positions and number of the sockets 5, 6 on the organiser unit 1 casing 2 may be varied. There may, for example, be only a single two-way USB port/socket to allow for data transfer and a separate charging-only socket which may be of the conventional barrel type. In this latter case a third USB Flash Drive/stick might be used by the system operator to upload exhibitor content to the organiser unit 1 and suitably would be identified by a corresponding identification code.

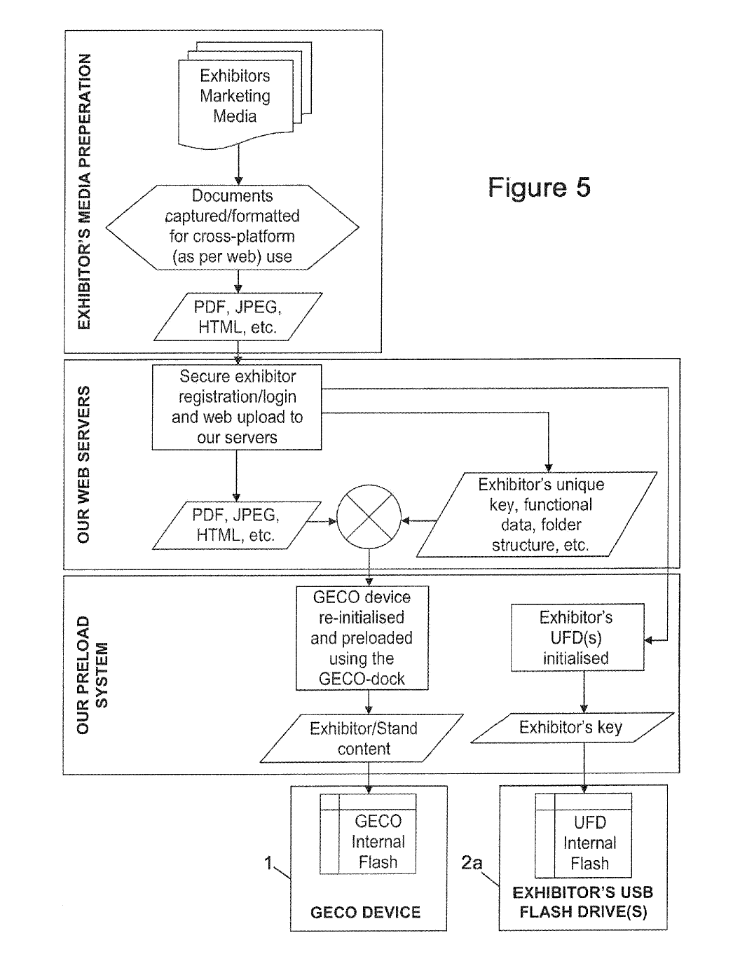

In operation, the system is initialised by first initialising each contact data organiser unit 1 for each exhibitor by uploading to it the exhibitor's data documents, unique exhibitor key, functional data and folder structure as illustrated in the information flow diagram of FIG. 5. At the same time the exhibitor's USB stick 2a is also initialised.

In FIG. 5, the exhibitor's data documents are captured in a fixed digital image form such as PDF or JPEG, HTML or the like. A common example would be a PDF catalogue of the exhibitor's services or products. Each such item is transmitted by the exhibitor to the system operator's server under secure exhibitor registration/login protocols. The data is there loaded onto the exhibitor's organiser unit 1 (and optionally also onto the exhibitor's USB stick 2a). A key unique to the exhibitor is downloaded onto the exhibitor's USB stick 2a from the system operator's server. The exhibitor's organiser unit 1 and exhibitor's USB stick 2a are then supplied to the exhibitor ahead of the exhibition.

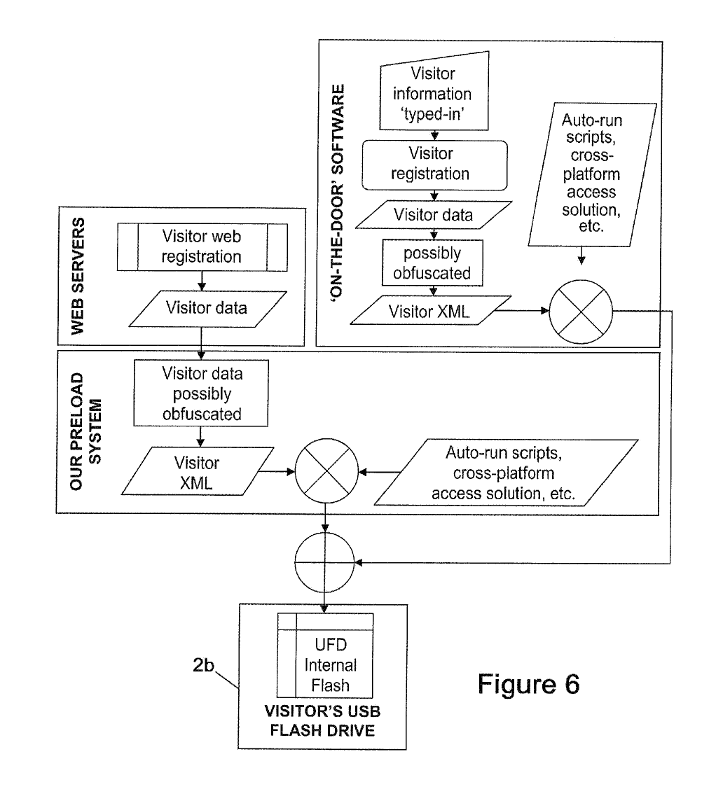

Referring to FIG. 6, this shows initialisation of the visitor USB stick 2b ahead of the exhibition. Data is captured from the website ticket application/registration process or by an on-the-door registration process onto the system operator's server and loaded by them onto the visitor USB stick 2b. If they have pre-registered on the web then the visitor's USB stick 2b may be sent to the visitor by post or else be handed to the visitor during on-the-door registration at the entrance to the exhibition.

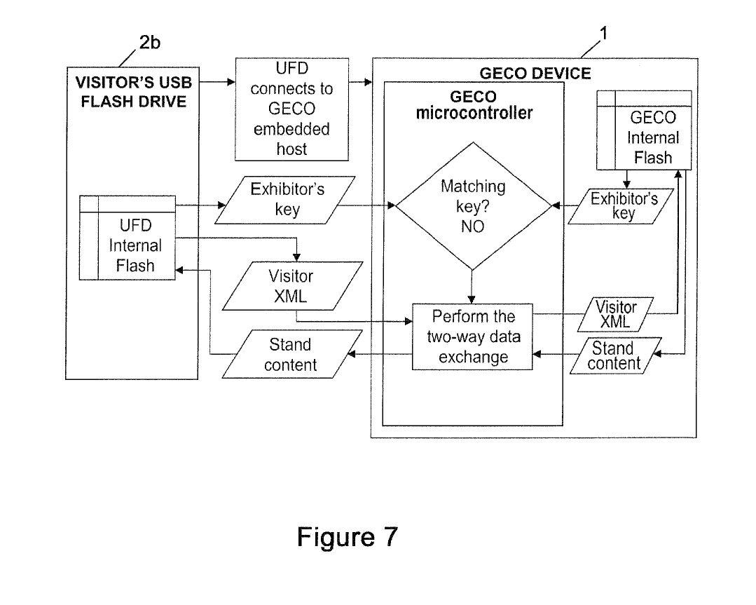

Referring to FIG. 7, once the exhibition is under way each visitor may insert their USB stick 2b into the socket 5 of a selected exhibitor's organiser unit 1. Firmware programmed into the ROM of the exhibitor's organiser unit 1 will transfer the catalogue to the visitor's USB stick 2b and the visitor's data will be transferred to the exhibitor's organiser unit 1.

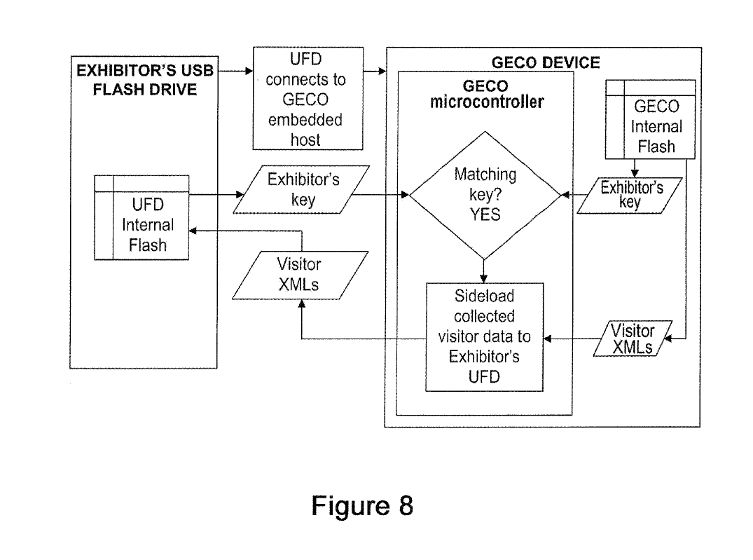

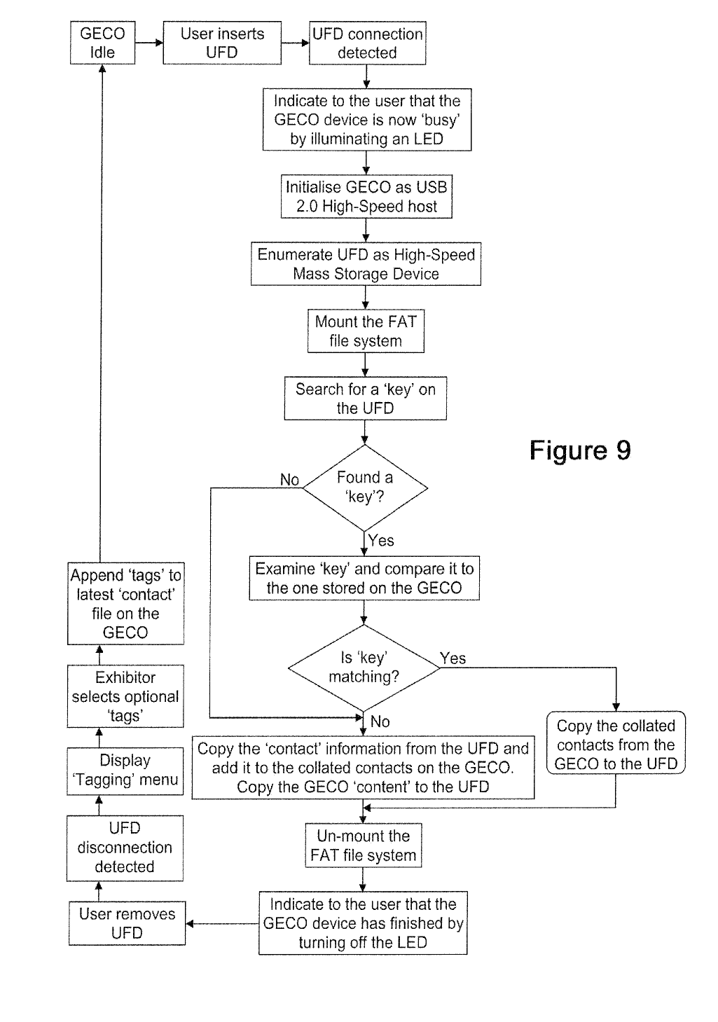

Referring to FIG. 8, generally at day end, the exhibitor plugs in his USB stick 2a and the collated visitor data is downloaded. Only the exhibitor can do this due to encryption or at least that this functionality is permitted only to the exhibitor through the exhibitor's USB stick 2a having the corresponding key to access the collated visitor information from his organiser unit 1. The logic process operated by the firmware in the ROM of the exhibitor's organiser unit 1 is illustrated in the flowchart of FIG. 9.

Data may also be sent to a central server at the venue as a fail-safe, enabling data recovery should a failure occur. Data sent to the server may be automatically sorted and a visitor file set up that shows the visitor's movements and preferences at the venue. Such data is valuable information for a marketing company. However, the system of the present invention will operate very effectively without need of such facility.

The organiser unit 1 and exhibitor USB stick 2b may be hired out to the exhibitor each day and sponsored visitor USB sticks 2b given to the visitors who have the option to re-use them if visiting another exhibition with this infrastructure in place.

At the door of the exhibition venue at least one USB dock may be provided for registering any previously unregistered visitors. Additional USB sticks may be made available for purchase for visitors who arrive without one or who have filled up their free USB stick (which is unlikely as these are suitably of 1 GB and an average PDF size of 2.5 MB is allocated).

The organiser unit 1 collects information that can then be used by the exhibitor to follow up enquiries and also stores detailed information about the visitor to the exhibition which, with permission previously granted by the visitor, could be sold to marketing companies. The cursor control 4 and display screen 3 of the organiser unit 1 can be used by the visitor to notify the exhibitor of follow-up action required such as, for example, selection of requirement for a meeting, phone call, letter or other message. The cursor control 4 and display screen 3 of the organiser unit 1 can also be used by the visitor or exhibitor for a range of other purposes such as categorising contacts using custom ‘tags’ or for assigning the contact to a particular representative.

Docking points may be provided where visitors can exchange information between each other and not need to hand out business cards. Flash software pre-loaded onto the visitor USB stick 2b auto runs (or where PC system security prevents auto-run, can be run by the user) once plugged into a PC running any major Operating System, such as Windows™, Linux™ or Mac OS X. This Flash software presents the exhibitor information collected by the user during the course of the exhibition.

The system, method and apparatus of the present invention helps to create a more environmentally responsible attitude and approach, which is long overdue in the business sector which currently still squanders natural resources.

1. A communication system for communication between exhibitors and visitors at trade fairs, exhibitions, conferences and the like, which comprises:
i) a dedicated contact data organiser unit, being a stand-alone handheld device comprising a processor housed in its own casing, the casing housing internal data storage and having at least one USB port; and
ii) a pair of USB flash drives, one configured for use by an exhibitor and the other configured for use by a visitor,
wherein, in use, the contact data organiser unit holds a first set of data of the exhibitor's products and services and will transfer that data to a visitor USB flash drive that is coupled to the USB port and will build and hold a second set of data of the visitors who have coupled their visitor USB flash drive to the contact data organiser unit.

2. A communication system as claimed in claim 1, wherein each exhibitor USB flash drive is issued with an electronic key or permission code for the exhibitor using that USB flash drive and associated contact data organiser unit.

3. A communication system as claimed in claim 2, wherein the processor of the contact data organiser unit is configured to check, whenever a USB flash drive is coupled to the USB port, whether the coupled USB flash drive has the required key or code to enable download of the second set of data to the exhibitor USB flash drive or to decrypt it.

4. A dedicated contact data organiser unit for use in a communication system for communication between exhibitors and visitors at trade fairs, exhibitions, conferences and the like, the unit being a stand-alone handheld device comprising a processor housed in its own casing, the casing housing internal data storage and having at least one USB port and the unit holding in use a first set of data of the exhibitor's products and services and being configured to transfer that data to a visitor USB flash drive that is coupled to the USB port and the unit further being configured to build and hold a second set of data of the visitors who have coupled their visitor USB flash drive thereto.

5. A dedicated contact data organiser unit as claimed in claim 4, wherein the casing further incorporates a display screen and a selector to select between options displayed on the screen.
